(19) United States
(12) Patent Application Publication
(10) Pub. No.: US 2005/0054550 A1
(43) Pub. Date: Mar. 10, 2005

(54) Process for preparing granulated acyloxybenzenesulfonates or acyloxybenzenecarboxylic acids and salts thereof

(75) Inventors: Georg Borchers, Bad Nauheim (DE); Alexander Lerch, Gelnhausen (DE); Gerd Reinhardt, Kelkheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 10/897,838

(22) Filed: Jul. 23, 2004

(30) Foreign Application Priority Data
Jul. 25, 2003 (DE) 10334046.7

(51) Int. Cl. C11D 1/00

(52) U.S. Cl. 510/424; 510/492

(57) ABSTRACT

A process is claimed for preparing granulated acyloxybenzenesulfonates which consists in granulating a mixture composed essentially of acyloxybenzenesulfonate and optical brightener.

The present invention relates to a process for preparing granulated acyloxybenzenesulfonates or acyloxybenzenecarbonates having good color quality by adding an optical brightener.

Acyloxybenzenesulfonic acids and their salts are compounds which have been known for a long time. Depending on the chain length of the acyl group they can be used as surfactants, as bleach activators or in other sectors. These compounds can be obtained by reacting sodium phenolsulfonate (SPS) with the chloride of an organic carboxylic acid. The reaction medium used comprises organic solvents such as methylene chloride (U.S. Pat. No. 3,503,888), high-boiling hydrocarbons (EP 220 826), xylene or toluene (EP 164 786). According to U.S. Pat. No. 5,069,828 this reaction is carried out in an aprotic organic solvent in the presence of a phase transfer catalyst.

WO 01/19 771 describes the reaction of acyl chlorides with SPS in trifluoroacetic acid (TFA) solvent. All of the processes are effected by the problem that SPS can undergo a series of side reactions, thereby significantly adversely affecting the color of the end products.

It is an object of the present invention, therefore, to develop a process for preparing granulated acyloxybenzenesulfonates which can be carried out both industrially and continuously and which leads to products of very great uniformity which are suitable in terms of composition and color for use in detergents. The process ought to be independent of the quality of the sodium phenolsulfonate used and of its pretreatment.

Surprisingly it has now been found that acyloxybenzenesulfonates or acyloxybenzenecarbonates can be prepared in good color quality if optical brighteners are added to them.

The invention provides a process for preparing granulated acyloxybenzenesulfonates or acyloxybenzenecarbonates which essentially comprises granulating a mixture of an acyloxybenzenesulfonate or acyloxybenzenecarbonates and an optical brightener.

Suitable acyloxybenzenesulfonates or acyloxybenzenecarbonates in accordance with the present invention include preferably compounds of the formula 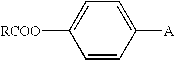
in which R is a C₁-C₁₈ linear or branched alkyl group, A is a group of the formula —SO₃M or —COOM and M is an alkali metal or alkaline earth metal ion. A particularly preferred compound is nonanoyloxybenzenesulfonate Na salt.

In accordance with a further embodiment it is also possible to granulate mixtures of acyloxybenzenesulfonates or acyloxybenzenecarbonates and structurally different bleach activators together with optical brighteners. Suitable for this purpose are in principle all known bleach activators which differ in their structure from the acyloxybenzenesulfonates or acyloxybenzenecarbonates. Examples of such different bleach activators include N,N,N′,N′-tetraacetylethylenediamine (TAED), nonanoylcaprolactam phenylsulfonate ester (APES), glucose pentaacetate (GPA), xylose tetraacetate (TAX), acyloxybenzenesulfonates [e.g., nonanoyloxybenzenesulfonate (NOBS), sodium 4-benzoyloxybenzenesulfonate (SBOBS), sodium trimethylhexanoyloxybenzenesulfonate (STHOBBS)], diacetyldioxohexahydrotriazine (DADHT), tetraacetylglycoluril (TAGU), tetraacetylcyanic acid (TACA), di-N-acetyldimethylglyoxime (ADMG), 1-phenyl-3-acetylhydantoin (PAH), nitrilotriacetate (NTA) or ammonium nitrites, an example being trimethylammonium acetonitrile chloride.

Suitable optical brighteners include all known optical brighteners, as described in “The Production and Application of Fluorescent Brightening Agents”, M. Zahradnik, Verlag Hohn Wiley & Sons, N.Y. (1982) and in Ullmann's Encyclopedia of Industrial Chemistry, “Optical Brighteners”, A. E. Siegrist, Eckhardt, J. Kaschig, E. Schmidt, Vol. A18, VCH Publishers, N.Y. (1991), pp. 153-176 CC.

Examples of compounds which can be used as optical brighteners include compounds from the series of the distyrylbenzenes, distyrylbiphenyls, diphenylstilbenes, triazinylaminostilbenes, stilbenyl-2H-triazoles, for example, stilbenyl-2H-naphthol-[1,2-d]triazoles and bis(1,2,3-triazol-2-yl)stilbenes, benzoxazoles, for example, stilbenylbenzoxazole and bis(benzoxazole), furans, benzofurans and benzimidazoles, for example, bis(benzo[b]furan-2-yl)biphenyl and cationic benzimidazoles, 1,3-diphenyl-2-pyrazoline, coumarin, naphthalimides, 1,3,5-2-yl derivatives, methine cyanine and dibenzothiophene 5,5-oxide.

Preference is given to anionic optical brighteners, especially sulfonated compounds.

Suitability here is possessed by bis(triazinylamino)stilbenes, preferably sulfonated 4,4′-bis(1,3,5-triazin-2-ylamino)stilbenes, especially those of the formula

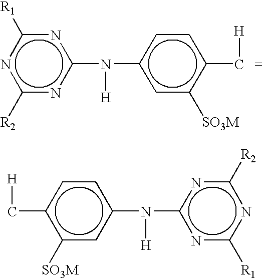

In this formula R₁ is a substituted amino group, preferably an anilino, p-sulfoanilino, N-2-hydroxyethyl or NH-2-hydroxyethyl group, R₂ is chlorine, hydroxyl, an amino or substituted amino group, for example methylamino, N-2-bis(hydroxyethyl)amino, N-2-hydroxyethyl-N-methylamino, NH-2-methoxyethyl, anilino or morphilino and M is H or an alkali metal or ammonium ion. The trans form is preferred.

Examples of this type of brightener include 4,4′-bis((4-anilino-6-bis(2-hydroxyethyl)-amino-1,3,5-triazin-2-yl)aminostilbene-2,2′-disulfonate, sodium salt, N-2-hydroxyethyl-N-2-methylamino)-1,3,5-triazin-2-yl)amino)stilbene-2,2′-disulfonate, sodium salt (TINOPAL 5BM), 4,4′-bis((4-amino-6-morpholino-1,3,5-triazin-2-yl)amino)stilbene-2,2′-disulfonate, sodium salt (TINOPAL AMS), TINOPAL DCS, where R₁ is p-sulfoanilino and R₂ is N-2-bis(hydroxyethyl)amino, TINOPAL LCS, where R₁ is anilino and R₂ is N-2-methoxyethylamino, TINOPAL TAS, where R₁ and R₂ are anilino, and BLANKOPHOR, where R₁ is anilino and R₂ is methylamino.

Further optical brighteners used with preference are distyrylbiphenyls, especially sulfonated 4,4′-bis(styryl)bisphenyls, of the formula 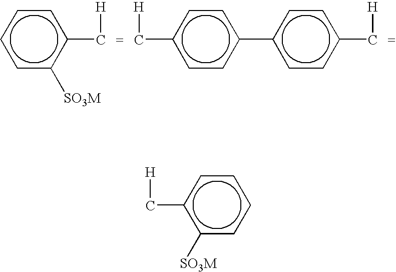
where M is H or alkali metal and the ethenyl groups preferably have the trans configuration. Mention may be made of 4,4′-bis(2-sulfostyryl)biphenyl, sodium salt (TINOPAL CBS).

Further suitable brighteners include triazinylaminostilbenes, distyrylbiphenyls and mixtures thereof, 2-(4-styrylphenyl)-2H-naphtho[1,2-d]triazole, 4,4′-bis(1,2,3-triazol-2-yl)stilbene, aminocoumarin, 4-methyl-7-ethylaminocoumarin, 1,2-bis(benzimidazol-2-yl)ethylene, 1,3-diphenylpyrazoline, 2,5-bis(benzoxazol-2-yl)thiophene, 2-styryl-naphtho[1,2-d]oxazole, 2-(4-styryl-3-sulfophenyl)-2H-naphtho[1,2-d]triazole and 2-(stilben-4-yl)-2H-naphtho[1,2-d]triazole.

The amount of brighteners in the acyloxybenzenesulfonates or acyloxybenzenecarbonates of the invention is from 0.001 to 2% by weight, preferably from 0.002 to 0.8% by weight, more preferably from 0.003 to 0.4% by weight.

Acyloxybenzenesulfonates are prepared by known methods by reacting anhydrous phenolsulfonates with carboxylic acid derivatives, the reaction being carried out advantageously with a salt of a phenolsulfonic acid that has a water content of less than 0.5% by weight and has been contacted with a substance having basic properties.

Acyloxybenzenesulfonate or acyloxybenzenecarbonate and optical brightener can be dry-mixed and subsequently compressed, using roll compactors for example. The compacted product is then size-reduced by customary methods and the fine fraction and coarse fraction are separated off by sieving. Preferably, however, the optical brightener is applied in solution form or in suspension form to the acyloxybenzenesulfonate. The moist mixture obtained in this way is then granulated by customary methods.

In order to improve the plastification and lubricity properties, but also the abrasion resistance of the bleach activator granules, it is possible in addition to add one or more components which are liquid at room temperature or are in melt form under the processing conditions.

Particularly suitable for this purpose are anionic and nonionic surfactants and polyalkylene glycols.

In one preferred embodiment the acyloxybenzenesulfonates or acyloxybenzenecarbonates are mixed with an anionic or nonionic surfactant and polyalkylene glycol and optical brightener, in solution where appropriate in a suitable medium, and the mixture is extruded at temperatures of from 40 to 90° C., preferably from 60 to 80° C., under a pressure of from 10 to 30 bar, and the resulting extrudates are granulated in a spheronizer at a temperature of from 40 to 90° C., preferably from 60 to 80° C.

Preferred anionic surfactants are alkali metal salts, ammonium salts, amine salts and salts of amino alcohols of the following compounds: alkyl sulfates, alkyl ether sulfates, alkyl amide sulfates and alkyl amide ether sulfates, alkylaryl polyether sulfates, monoglyceride sulfates, alkylsulfonates, alkylamidesulfonates, alkylarylsulfonates, α-olefinsulfonates, alkylsulfosuccinates, alkyl ether sulfosuccinates, alkylamidesulfosuccinates, alkylsulfoacetates, alkylpolyglycerolcarboxylates, alkyl phosphates, alkyl ether phosphates, alkylsarcosinates, alkylpolypeptidates, alkylamidopolypeptidates, alkylisethionates, alkyltaurates, alkylpolyglycol ether carboxylic acids or fatty acids, such as oleic acid, ricinoleic acid, palmitic acid, stearic acid, and hydrogenated or non-hydrogenated salts of copra oil acid. The alkyl radical of all of these compounds normally contains 8-32 carbon atoms, preferably 8-22 carbon atoms. Particular preference is given to linear straight-chain alkylbenzenesulfonates, particularly having a C₈-C₂₀ alkyl group and more preferably having a C₁₁-C₁₃ alkyl group.

Preferred nonionic surfactants are polyethoxylated, polypropoxylated or polyglycerolated ethers of fatty alcohols, polyethoxylated, polypropoxylated and polyglycerolated fatty acid esters, polyethyloxylated esters of fatty acids and of sorbitol, and polyethoxylated or polyglycerolated fatty amides.

Suitable polyalkylene glycols include polyethylene glycols, 1,2-polypropylene glycols and also modified polyethylene glycols and polypropylene glycols. Modified polyalkylene glycols include, in particular, sulfates and/or disulfates of polyethylene glycols or polypropylene glycols having a relative molecular mass of between 600 and 12000 and in particular between 1000 and 4000. Another group consists of monosuccinates and/or disuccinates of polyalkylene glycols which in turn have relative molecular masses of between 600 and 6000, preferably between 1000 and 4000. Also include are ethoxylated derivatives such as trimethylolpropane with from 5 to 30 EO.

The polyethylene glycols used with preference may have a linear or branched structure, particularly preference being given to linear polyethylene glycols. The particularly preferred polyethylene glycols include those having relative molecular masses of between 2000 and 12000, advantageously around 4000, it being possible to use polyethylene glycols having relative molecular masses of below 3500 and above 5000 in particular in combination with polyethylene glycols having a relative molecular mass of around 4000; advantageously, such combinations contain more than 50% by weight, based on the total amount of the polyethylene glycols, of polyethylene glycols having a relative molecular mass of between 3500 and 5000.

The modified polyethylene glycols also include singly or multiply endgroup-capped polyethylene glycols, the end groups being preferably C₁-C₁₂ alkyl chains, more preferably C₁-C₆, which may be linear or branched. Singly endgroup-capped polyethylene glycol derivatives may also be of the formula R(EO)_{y}(PO)z where R can be an alkyl group having a C chain length of from 1 to 20, y can be numbers from 50 to 500 and z can be numbers from 0 to 20.

Likewise suitable are low molecular mass polyvinylpyrrolidones and derivatives of these having relative molecular masses of up to a maximum of 30 000. Preference is given here to relative molecular mass ranges between 3000 and 30 000. Polyvinyl alcohols are used preferably in combination with polyethylene glycols.

Particular preference is given to using PEG 4000 in the process of the invention.

In order to improve the plastification and lubricity properties it is also possible additionally to add linear or branched fatty acids, especially nonanoic acid or ethoxylated fatty acids with from 2 to 100 EO.

The above-described mixture of all the components may further comprise small amounts of a solvent, preferably less than 15% by weight, more preferably less than 10% by weight, very preferably less than 7% by weight.

Further suitable additions are substances which influence the pH during storage and application. These include organic carboxylic acids or their salts, such as citric acid in anhydrous or hydrated form, glycolic acid, succinic acid, maleic acid or lactic acid. Also possible are additions which influence the bleaching capacity, such as complexing agents and transition metal complexes, e.g., iron-, cobalt- and/or manganese-containing metal complexes as described in EP-A-0 458 397 and EP-A-0 458 398.

Particularly advantageous embodiments of the invention comprise as bleach activator the sodium salt of nonanoyloxyphenylsulfonate (NOBS), as solubilizers linear straight-chain alkylbenzenesulfonates, particularly those having a C₈-C₂₀-alkyl group and more preferably a C₁₁-C₃-alkyl group (LAS), nonanoic acid and polyethylene glycol (PEG) 4000 as consistency agents and plasticizers, the fraction of NOBS being from 70 to 90% by weight, more preferably from 80 to 87% by weight, very preferably from 81 to 85% by weight, the proportion of LAS being from 2 to 10% by weight, preferably from 3 to 5% by weight, more preferably from 3.7 to 4.5% by weight, the proportion of nonanoic acid being from 0.1 to 6% by weight, more preferably from 1 to 4% by weight, very preferably from 2.5 to 3.5% by weight, the proportion of PEG 4000 being from 1 to 15% by weight, more preferably from 5 to 10% by weight, very preferably from 7 to 8% by weight, and also optical brightener, preferably a 4,4′-distyrylbiphenyl derivative (TINOPAL CBS-X, Ciba Geigy) or a bis(triazinylamino)stilbenedisulfonic acid derivative (TINOPAL DMS-X, Ciba Geigy), in amounts by weight of from 0.001 to 2% by weight, more preferably from 0.002 to 0.8% by weight, very preferably from 0.003 to 0.4% by weight.

Advantageously bleach activator, nonanoyloxyphenylsulfonate (NOBS) for example, and anionic and/or nonionic surfactant, alkylbenzenesulfonate (LAS) for example, are mixed in powder form in a ploughshare mixer (e.g., from Lödige) and the mixture is heated to from 60° C. to 70° C. A mixture of plasticizer, nonanoic acid for example, polyethylene glycol, PEG 4000 for example, and optical brightener is introduced into the mixture of bleach activator and surfactant, which is being heated to from 60 to 70° C., at from 70 to 90° C., preferably 80° C., over the course of 60 sec at a rotational speed of 50-150 min⁻¹. During the preparation of the mixture of liquids, filtration to remove undissolved fractions of brightener may prove advantageous prior to further processing. Thereafter the product mixture is extruded at a temperature in the range from 60 to 70° C. under a pressure of from 14 bar to 22 bar. In one preferred embodiment of the invention the mixture is supplied continuously to a single-screw extruder or twin-screw extruder, with corotating or counterrotating screws, the barrel of which and the extruder-granulator head of which may have been heated to the predetermined extrusion temperature. Under the shearing action of the extruder screws the mixture is compacted under pressure, plasticized, extruded in the form of strands through the perforated die plate in the extruder head, powdered where appropriate with finely particulate anticaking agent, such as TiO2, silica, zeolite or its dust, for example, reduced in size to form coarse straw sections, and transferred to a spheronizer which has been heated to from 40 to 90° C., preferably from 60 to 80° C., in particular from 60 to 65° C. The subsequent spheronizing process gives granules varying in form from cylindrical to spherical and having defined particle sizes and a very narrow particle size distribution, the particle diameter being between 0.2 mm and 2 mm, preferably between 0.5 mm and 0.8 mm and the length of the particles being in the range from 0.5 mm to 3.5 mm, ideally between 0.9 mm and 2.5 mm. The extrudates are fed directly to the spheronizer or where appropriate are coarsely comminuted beforehand. In one preferred embodiment the shaping operation of the invention is carried out continuously in cascade operation, although batchwise operation is also possible.

The size and shape of the particles can be influenced and brought about in the spheronizing process by means of a plurality of parameters. The shaping operation is determined by the fill level, the temperature of the mixture, the residence time of the mixture in the spheronizer, the rotation speed of the spheronizing disc, and the plastic deformability of the mixture.

As the fill level in the spheronizer decreases, shorter cylinder granules and a narrower particle size distribution are obtained. As the temperature decreases and the plasticity hence becomes less, longer granules are obtained, and on further cooling the dust fraction increases considerably.

The residence time of the mixture in the spheronizer depends not only on the plasticity but also on the fill level and is preferably from 10 to 120 sec, more preferably from 20 to 60 sec, while the peripheral speed is from 10 m/sec to 30 m/sec, preferably from 12 m/sec to 20 m/sec.

In one particular embodiment the temperature in the spheronizer is controlled by supply of a stream of air or gas (N₂), preferably via the gap apparatus. The temperature of the air or gas streams is from 50 to 120° C., preferably from 60 to 90° C., so that, after spheronizing has taken place in each case, the desired operating temperature in the spheronizer can be maintained.

After the shaping operation, the cylindrically shaped and rounded particles are cooled in a downstream apparatus, preferably in a fluidized-bed cooler in a stream of cold air or gas, to temperatures below 40° C. in order to prevent sticking of the granules.

Examples below are intended to illustrate the invention, without restricting it thereto.

### EXAMPLE 1

Preparation of NOBS Granules without Optical Brightener

254.7 g (85.65% by weight) of nonanoyloxybenzenesulfonate, Na (NOBS) and 12.8 g (4.30% by weight) of linear C₁-C₁₃ alkylbenzenesulfonate, Na salt (LAS) are mixed homogeneously and heated to 60.7° C. 8.8 g (2.96% by weight) of nonanoic acid and 21.1 g (7.09% by weight) of polyethylene glycol 4000 are heated to 80° C. and are metered into the NOBS/LAS mixture over a period of 18 sec in a ploughshare mixer from Lödige at a rotational speed of 135 min⁻¹, and the two mixtures are mixed together homogeneously for a further 42 sec.

The resulting pasty mixture is transferred at a temperature of 65 to 71° C. to a single-screw dome extruder from Fuji-Paudal, the die of which has a bore diameter of 0.7 mm, and is extruded at an extruder screw rotational speed of 45 per minute with a throughput of about 287 g/min. Subsequently the extrudate is brought to particle sizes of d=0.7 mm and I=1.4 mm at a temperature of 65 to 69° C. in a batch spheronizer from Fuji-Paudal having a diameter of 0.23 m at a rotational speed of 1245 per minute, a peripheral speed of 15.71 m/sec and a residence time of 30 seconds.

### EXAMPLE 2

Preparation of NOBS Granules with 0.05% by Weight of Optical Brightener (TINOPAL CBS-X)

254.7 g (85.71 % by weight) of nonanoyloxybenzenesulfonate, Na (NOBS) and 12.6 g (4.24% by weight) of linear C₁₁-C₁₃ alkylbenzenesulfonate, Na salt (LAS) are mixed homogeneously and heated to 63.1° C. 21.0 g (7.07% by weight) of polyethylene glycol 4000 are heated at 80° C. and melted and thereafter mixed with 8.7 g (2.93% by weight) of nonanoic acid and 0.16 g (0.05% by weight) of TINOPAL CBS-X in a stirring vessel. Subsequently the mixture, at a temperature of 80° C., is metered into the NOBS/LAS mixture over a period of 18 sec in a ploughshare mixer from Lödige at a rotational speed of 135 min⁻¹, and the two mixtures are mixed together homogeneously for a further 42 sec.

The resulting pasty mixture is transferred at a temperature of 65 to 71° C. to a single-screw dome extruder from Fuji-Paudal, the die of which has a bore diameter of 0.7 mm, and is extruded at an extruder screw rotational speed of 45 per minute with a throughput of about 260 g/min. Subsequently the extrudate is brought to particle sizes of d=0.7 mm and I=1.4 mm at a temperature of 65 to 69° C. in a batch spheronizer from Fuji-Paudal having a diameter of 0.23 m at a rotational speed of 1245 per minute, a peripheral speed of 15.71 m/sec and a residence time of 30 seconds.

### EXAMPLE 3

Preparation of NOBS Granules with 0.40% by Weight of Optical Brightener (TINOPAL CBS-X)

254.8 g (85.39% by weight) of nonanoyloxybenzenesulfonate, Na (NOBS) and 12.5 g (4.22% by weight) of linear C₁₁-C₁₃ alkylbenzenesulfonate, Na salt (LAS) are mixed homogeneously and heated to 61.6° C. 20.9 g (7.04% by weight) of polyethylene glycol 4000 are heated at 80° C. and melted and thereafter mixed with 8.8 g (2.95% by weight) of nonanoic acid and 1.2 g (0.4% by weight) of TINOPAL CBS-X in a stirring vessel. Subsequently the mixture, at a temperature of 80° C., is metered into the NOBS/LAS mixture over a period of 18 sec in a ploughshare mixer from Lödige at a rotational speed of 135 min⁻¹, and the two mixtures are mixed together homogeneously for a further 42 sec.

The resulting pasty mixture is transferred at a temperature of 65 to 71° C. to a single-screw dome extruder from Fuji-Paudal, the die of which has a bore diameter of 0.7 mm, and is extruded at an extruder screw rotational speed of 45 per minute with a throughput of about 287 g/min. Subsequently the extrudate is brought to particle sizes of d=0.7 mm and I=1.4 mm at a temperature of 65 to 69° C. in a batch spheronizer from Fuji-Paudal having a diameter of 0.23 m at a rotational speed of 1245 per minute, a peripheral speed of 15.71 m/sec and a residence time of 30 seconds.

### EXAMPLE 4

Preparation of NOBS Granules with 0.8% by Weight of Optical Brightener (TINOPAL CBS-X)

254.6 g (84.33% by weight) of nonanoyloxybenzenesulfonate, Na (NOBS) and 12.6 g (4.17% by weight) of linear C₁₁-C₁₃ alkylbenzenesulfonate, Na salt (LAS) are mixed homogeneously and heated to 61.6° C. 22.8 g (7.55% by weight) of polyethylene glycol 4000 are heated at 80° C. and melted and thereafter mixed with 9.5 g (3.15% by weight) of nonanoic acid and 2.4 g (0.79% by weight) of TINOPAL CBS-X in a stirring vessel. Subsequently the mixture, at a temperature of 80° C., is metered into the NOBS/LAS mixture over a period of 18 sec in a ploughshare mixer from Lödige at a rotational speed of 135 min⁻¹, and the two mixtures are mixed together homogeneously for a further 42 sec.

The resulting pasty mixture is transferred at a temperature of 65 to 71° C. to a single-screw dome extruder from Fuji-Paudal, the die of which has a bore diameter of 0.7 mm, and is extruded at an extruder screw rotational speed of 45 per minute with a throughput of about 261 g/min. Subsequently the extrudate is brought to particle sizes of d=0.7 mm and I=1.4 mm at a temperature of 65 to 69° C. in a batch spheronizer from Fuji-Paudal having a diameter of 0.23 m at a rotational speed of 1245 per minute, a peripheral speed of 15.71 m/sec and a residence time of 30 seconds.

TABLE 1
Determination of the lightness and of the shift in the
Hunter color scale of NOBS granules as a function of the
concentration of optical brightener Tinopal CBS-X

| Optical brightener | Tinopal CBS-X | | | |
|---|---|---|---|---|
| Conc. of optical brightener | 0 | 0.05 | 0.4 | 0.8 |
| L (CBS-x) | 80.17 | 80.96 | 81.58 | 82.71 |
| a (CBS-X) | 0.31 | 2.24 | 1.82 | 1.05 |
| b (CBS-x) | 9.50 | 4.09 | 1.86 | 1.02 |

L: Lightness
a: Red-green color shift on the Hunter color scale
b: Blue-yellow color shift on the Hunter color scale

The lightness L and the color shift values a and b were determined using a LabScan XE LSXE and a calorimeter with HunterLab DP-9000 Processor, UV Control (HunterLab).

The granules obtained in this way are distinguished by significantly improved color quality as compared with granules of the same composition but without optical brightener.

The granules of the invention that are obtained are suitable directly for use in detergents. They can be provided with a coating shell where appropriate.

Further possible additions are substances which react in the wash liquor with the peroxicarboxylic acid released from the activator to form a reactive intermediates, such as dioxiranes or oxaziridines, and in that way are able to increase the reactivity. Corresponding compounds are ketones and sulfonimines corresponding to U.S. Pat. No. 3,822,114 and EP-A-0 446 982.

The amount of the additive is guided in particular by its type. For instance, acidifying additions and organic catalysts are added in order to boost the performance of the peracid in amounts of from 0 to 20% by weight, in particular in amounts of from 1 to 10% by weight, based on the total weight, whereas metal complexes are added in concentrations in the ppm range.

The granules obtained are distinguished by very good color quality, abrasion resistance and storage stability in pulverulent laundry detergent, cleaning product and disinfectant formulations. They are ideally suitable for use in heavy-duty detergents, scouring salts, machine dishwashing detergents, general-purpose cleaners in powder form, and denture cleansers.

In these formulations the granules of the invention are employed generally in combination with a hydrogen peroxide source. Examples of such a source include perborate monohydrate, perborate tetrahydrate, percarbonates, and adducts of hydrogen peroxide with urea or amine oxides. The formulation may further comprise additional, prior art laundry detergent ingredients, such as organic and inorganic builders and cobuilders, surfactants, enzymes, brighteners and perfume.

1. A process for preparing granulated acyloxybenzenesulfonates or acyloxybenzenecarbonates, which comprises granulating a mixture composed essentially of acyloxybenzenesulfonate or acyloxybenzenecarbonate and optical brightener to provide a granule.

2. The process of claim 1, wherein the acyloxybenzenesulfonates have the formula 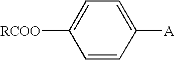
in which R is a linear or branched alkyl group having 1 to 18 carbon atoms, A is a group of the formula —SO₃M or —COOM and M is hydrogen or an alkali metal or alkaline earth metal ion.

3. The process as claimed in claim 1, wherein the acyloxybenzenesulfonates comprise a sodium salt of nonanoyloxybenzenesulfonate.

4. The process as claimed in claim 1, wherein the granule comprises from 0.001 to 2% by weight of optical brightener.

5. The process as claimed in claim 1, wherein the acyloxybenzenesulfonates and optical brightener are dry-mixed and compressed to form a compacted product and the compacted product is comminuted.

6. The process as claimed in claim 1, wherein the optical brightener is applied in solution form or suspension form to the acyloxybenzenesulfonates and subsequently granulation is carried out.

7. The process as claimed in claim 1, wherein the mixture further comprises compounds which improve the plastification and lubricity properties prior to granulating.

8. The process as claimed in claim 1, wherein a component selected from the group consisting of anionic surfactants, nonionic surfactants, polyalkylene glycols, and mixtures thereof is added to the mixture prior to said granulating.
